(19) United States
(12) Patent Application Publication
(10) Pub. No.: US 2014/0302795 A1
(43) Pub. Date: Oct. 9, 2014

(54) USER IDENTIFICATION METHOD FOR AUTOMATED FURNITURE

(71) Applicant: L&P PROPERTY MANAGEMENT COMPANY, South Gate, CA (US)

(72) Inventors: RYAN CHACON, CARTHAGE, MO (US); WILLIAM ROHR, JOPLIN, MO (US); AVINASH MADADI, WEBB CITY, MO (US)

(21) Appl. No.: 14/311,243

(22) Filed: Jun. 21, 2014

Related U.S. Application Data
(63) Continuation-in-part of application No. 14/164,132, filed on Jan. 24, 2014.
Application No. 14/164,132 is a continuation-in-part of application No. 13/749,087, filed on Jan. 24, 2013.

(51) Int. Cl. H04W 4/00

(52) U.S. Cl. CPC H04W 4/008
USPC 455/41.3

(57) ABSTRACT

A method of user identification in association with an automated furniture item is provided. In embodiments, a user identification method for an automated furniture item utilizes occupancy detection and proximity detection, such as via a BLE PXP. In some embodiments, a system associated with an automated furniture item is provided, which identifies a particular user's smart device (i.e., a device configured to connect to one or more other devices and/or networks, such as a tablet computing device or smartphone) within range of the automated furniture item controller, and generates a corresponding response based on occupancy detection of that particular user. In another embodiment, one or more environment features may be controlled and/or activated, in association with the automated furniture item, based on the coordinated response of both the proximity indication of user identity and the presence detection of a particular user with respect to the automated furniture item.

### CROSS-REFERENCE TO RELATED APPLICATIONS

This application is a continuation-in-part of U.S. Nonprovisional patent application Ser. No. 14/164,132, filed Jan. 24, 2014, entitled “Wireless Two-Way Communication Protocol for Automated Furniture Accessory Integration,” having Attorney Docket No. LGPL.202062, which is a continuation-in-part of U.S. Nonprovisional patent application Ser. No. 13/749,087, filed Jan. 24, 2013, entitled “Wireless Two-Way Communication Protocol for Automated Furniture Accessory Integration,” having Attorney Docket No. LGPL.169176, the contents of both of which are hereby incorporated by reference in their entirety.

### STATEMENT REGARDING FEDERALLY SPONSORED RESEARCH OR DEVELOPMENT

Not applicable.

### TECHNICAL FIELD

Embodiments of the present invention relate to user identification for an automated furniture item. More particularly, embodiments of the present invention relate to a user identification system and method for an automated furniture item using occupancy detection and proximity detection, such as proximity detected in association with a Bluetooth low energy (BLE) proximity profile (PXP).

In further embodiments, the invention generally relates to a wireless, two-way communication protocol for integrating furniture accessories and generic devices with automated furniture items. Some embodiments of the invention are directed to a communication protocol for using a remote device to control automated furniture accessories and/or generic devices coupled to a control component of an automated furniture item.

### BACKGROUND OF THE INVENTION

A variety of methods exist for using a controller to manipulate an automated furniture item. Such controllers direct the operation of various “standard” integrated elements for automated furniture items, such as a head motor or foot motor on an adjustable bed. However, external accessories may also be provided for use with an automated furniture item, such as a heating blanket. Unless the heating blanket is integrated into the control system of the automated furniture item, it will likely be controlled separately from the furniture item, requiring an additional device and/or remote. Further, the controller of an automated furniture item is typically equipped with the necessary firmware to operate the standard devices provided with the furniture item (i.e., those devices that the manufacturer intended to be operated by the furniture item controller). Accordingly, a need exists for a communication protocol that enables additional, automated furniture accessories and/or external, generic wireless devices to be operated by an automated furniture controller without the need to update the firmware of the furniture item controller.

Additionally, in a traditional automated furniture setting, occupancy detection systems may be used to generate an indication of presence (or absence) of a user in relation to the automated furniture item, regardless of the particular user's identity. Similarly, automated furniture items may be configured to receive signals from a remote controlling mechanism (utilizing one of a variety of wired and/or wireless communication protocols), regardless of the identity of the user providing the input to the controlling mechanism (e.g., the wireless device user). As such, embodiments of the present invention provide a system and method of user identification for automated furniture that not only responds to anonymous triggers via an indication of occupancy but identifies the particular occupant and generates a corresponding, user-specific response by the automated furniture item and/or other generic devices associated with the automated furniture item.

### BRIEF SUMMARY OF THE INVENTION

Embodiments of the present invention generally relate to a user identification system and method for an automated furniture item using occupancy detection and proximity detection, such as via a BLE PXP. In embodiments of the invention, a system associated with an automated furniture item is provided, which identifies a particular user's smart device (i.e., a device configured to connect to one or more other devices and/or networks, such as a tablet computing device or smartphone) within range of the automated furniture item controller, and generates a corresponding response based on occupancy detection of that particular user. In another embodiment, one or more environment features may be controlled and/or activated, in association with the automated furniture item, based on the coordinated response of both the proximity indication of user identity and the presence detection of a particular user with respect to the automated furniture item.

Accordingly, in one embodiment of the invention, a user identification method for automated furniture is provided. The method includes: receiving, by a control component of an automated furniture item, an indication of first user proximity based on a proximity profile of a first user device; based at least in part on the received indication of first user proximity, generating at least one first user-specific command associated with the automated furniture item; and communicating the generated at least one first user-specific command to the first user device.

In another illustrative aspect, a user identification method for automated furniture includes: monitoring, via a control component of an automated furniture item, a proximity associated with an automated furniture item; receiving an indication that a proximity threshold is satisfied by a first user device; monitoring occupancy detection associated with the automated furniture item; receiving a first indication that an occupancy threshold is satisfied for the automated furniture item; based on one or more of the satisfied proximity threshold and the satisfied occupancy threshold, communicating a notification to connect the first user device to the control component of the automated furniture item; receiving an indication to connect the first user device to the control component; and communicating one or more first user-specific controls to the first user device.

According to a third illustrative aspect, a method for user identification for an automated furniture item utilizing occupancy detection and a BLE PXP is provided. Embodiments of the method include: receiving a first indication of proximity of a particular user device in association with the automated furniture item based on a BLE PXP associated with the control component of the automated furniture item, wherein the particular user device is associated with a particular user; receiving a first indication of occupancy in association with the automated furniture item based on an occupancy detection component coupled to the control component of the automated furniture item; and in response to the received first indication of proximity of the particular user device and the received first indication of occupancy, generating one or more control features for the particular user device.

In another illustrative embodiment of the invention, a system for integrating automated furniture accessories with automated furniture items includes a control component having: (1) a wireless communication device; (2) a CAN bus; and (3) at least one automated furniture accessory coupled to the CAN bus, wherein one or more features of the at least one automated furniture accessory are controlled by a remote device wirelessly coupled to the control component.

In another illustrative aspect, a method for integrating automated furniture accessories with automated furniture items includes: receiving an indication of an automated furniture accessory coupled to a control component; identifying one or more packets of information associated with the automated furniture accessory; and communicating at least one of the one or more packets of information to a remote device, wherein the remote device is adapted to control one or more features of the automated furniture accessory based at least in part on communication between the remote device and the control component.

According to a further illustrative aspect, embodiments of a method for integrating automated furniture accessories with automated furniture items includes: receiving one or more items of identifying information associated with at least one automated furniture accessory coupled to a control component and communicating at least one of the one or more items of identifying information to a remote device, wherein the remote device is in wireless, two-way communication with the control component, wherein one or more features of the at least one automated furniture accessory are controlled by the remote device based on communication of the at least one of the one or more items of identifying information.

Another illustrative aspect of an embodiment of the invention includes a system for integrating one or more generic devices with an automated furniture item. The system includes a first generic device having a first wireless communication device; and a control component coupled to the first generic device, the control component including a second wireless communication device. In embodiments, one or more features of the first generic device are controlled by a remote device wirelessly coupled to the control component, said remote device including a third wireless communication device.

According to yet another illustrative aspect, an embodiment of the invention includes a method for integrating generic devices with automated furniture items. The method includes: receiving, by a control component of an automated furniture item, an indication of at least one generic device wirelessly coupled to the control component, wherein the at least one generic device is external to the control component; receiving a first command from a remote device wirelessly coupled to the control component, wherein the first command corresponds to one or more features of the at least one generic device; wirelessly communicating the received first command from the control component to the at least one generic device; receiving an indication of occupancy associated with the automated furniture item; based at least in part on the received indication of occupancy, determining a second command corresponding to a feature of the at least one generic device; and wirelessly communicating the determined second command from the control component to the at least one generic device.

One illustrative aspect of the invention is directed to a method for establishing a particular user environment corresponding to occupancy detection for an automated furniture item coupled to at least one generic device. The method includes: receiving an indication of a particular user environment selection from a remote device, the particular user environment selection comprising a set of commands corresponding to settings of the particular user environment for at least one generic device coupled to a control component of the automated furniture item; communicating at least one primary command corresponding to the received user environment selection from the control component to the at least one generic device wirelessly coupled to the control component; receiving an indication of a change in occupancy detection associated with the automated furniture item; determining at least one secondary command based at least in part on: (1) the set of commands for the at least one generic device; and (2) the received change in occupancy detection; and communicating the at least one secondary command to the at least one generic device coupled to the control component.

Additional objects, advantages, and novel features of the invention will be set forth in part in the description that follows, and in part will become apparent to those skilled in the art upon examination of the following, or may be learned by practice of the invention.

### BRIEF DESCRIPTION OF SEVERAL VIEWS OF THE DRAWINGS

The present invention is described in detail below with reference to the attached drawing figures, wherein:

FIG. 1 is a system for integrating automated furniture accessories with automated furniture items, in accordance with an embodiment of the invention;

FIG. 2 is the system of FIG. 1 for integrating automated furniture accessories with automated furniture items, including a plurality of packets of a communication protocol, in accordance with an embodiment of the invention;

FIG. 3 is a flow diagram of a method for integrating automated furniture accessories with automated furniture items, in accordance with an embodiment of the invention;

FIG. 4 is a flow diagram of a method for integrating automated furniture accessories with automated furniture items, in accordance with an embodiment of the invention;

FIG. 5 is a system for integrating generic devices with automated furniture items, in accordance with an embodiment of the invention;

FIG. 6 is a system for integrating generic devices with automated furniture items, in accordance with an embodiment of the invention;

FIG. 7 is a flow diagram of a method for integrating generic devices with automated furniture items, in accordance with an embodiment of the invention;

FIG. 8 is a flow diagram of a method for integrating generic devices with automated furniture items, in accordance with an embodiment of the invention;

FIG. 9 is a flow diagram of an exemplary method of user identification for an automated furniture item, in accordance with an embodiment of the invention;

FIG. 10 is an exemplary diagram of a system for user identification for an automated furniture item, in accordance with embodiments of the invention;

FIG. 11 is a flow diagram of an exemplary method of user identification for an automated furniture item, in accordance with an embodiment of the invention;

FIG. 12 is a flow diagram of an exemplary method of user identification for an automated furniture item, in accordance with an embodiment of the invention;

FIG. 13 is a flow diagram of an exemplary method of user identification for an automated furniture item, in accordance with an embodiment of the invention;

FIG. 14 is a flow diagram of an exemplary method of user identification for an automated furniture item, in accordance with an embodiment of the invention; and

FIG. 15 is a flow diagram of an exemplary method of user identification for an automated furniture item, in accordance with an embodiment of the invention.

### DETAILED DESCRIPTION OF THE INVENTION

Embodiments of the present invention generally relate to a user identification system and method for an automated furniture item using occupancy detection and proximity detection, such as via a BLE PXP. In embodiments of the invention, a system associated with an automated furniture item is provided, which identifies a particular user's smart device (i.e., a device configured to connect to one or more other devices and/or networks, such as a tablet computing device or smartphone) within range of the automated furniture item controller, and generates a corresponding response based on occupancy detection of that particular user. In another embodiment, one or more environment features may be controlled and/or activated, in association with the automated furniture item, based on the coordinated response of both the proximity indication of user identity and the presence detection of a particular user with respect to the automated furniture item.

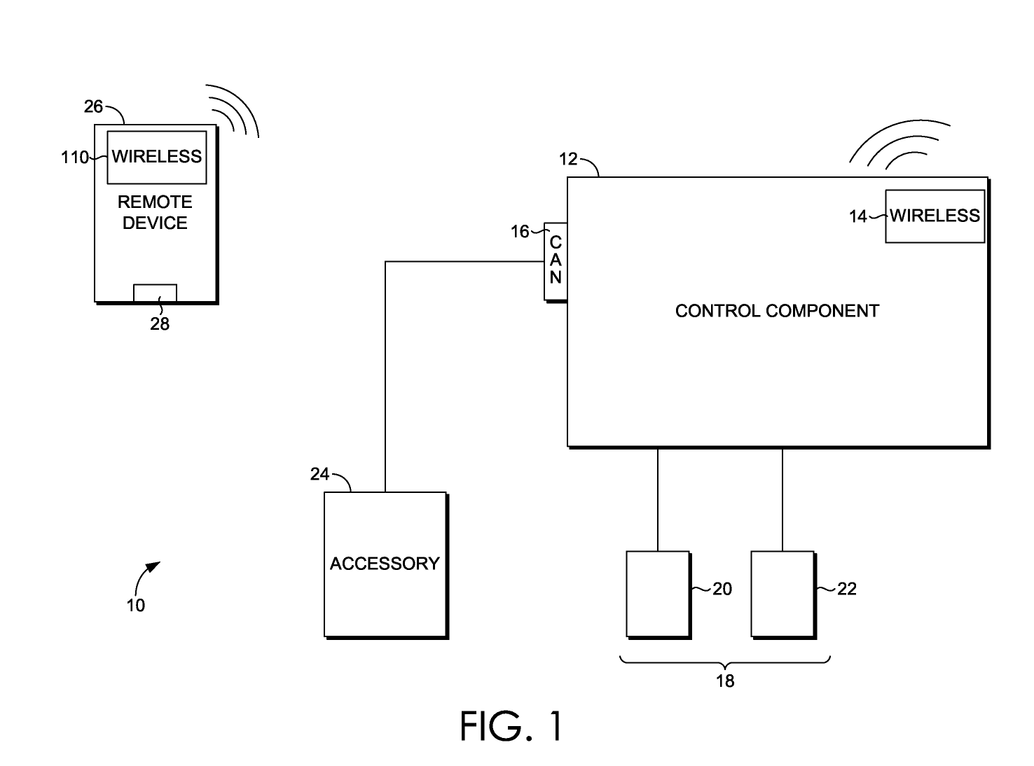

An embodiment of a system 10 for integrating automated furniture accessories with automated furniture items is seen in FIG. 1. In the embodiment of FIG. 1, the system 10 generally includes a control component 12 having a wireless communication device 14, a controller area network (CAN) bus 16, integrated features 18 including a head motor 20 and a foot motor 22, and an automated furniture accessory 24 coupled to the CAN bus 16 of the control component 12. Further, the control component 12 is depicted as being in wireless communication with a remote device 26 having a data port 28 and a wireless communication device 110.

In one embodiment, control component 12 controls various features of an automated furniture item that are operated based on commands received by the control component 12. For example, the control component 12 may control integrated features 18 that are integral to the operation of the automated furniture item, such as a head motor 20 that raises and lowers the head of an adjustable bed. Although exemplary integrated features 18 are shown in FIG. 1, such as the head motor 20 and the foot motor 22, it should be understood that any number or combination of integrated features 18 may be coupled to the control component 12, such as a massage motor, a programming port, a wired remote device, and the like.

In some embodiments, the control component 12 includes a processor and a memory capable of receiving and processing commands that are identifiable using the firmware of the control component 12. For example, the control component 12 may receive a command to operate one or more of the integrated features 18 coupled to the automated furniture item. Accordingly, a remote device 26 may receive an input command from a user, which the remote device 26 transmits, wirelessly, to the wireless communication device 14 of control component 12, using wireless communication device 110. The command may relate to one or more of the integrated features 18 coupled to the control component 12, such as a command to lower both the head and the foot of an automated bed (using head motor 20 and foot motor 22).

Wireless communication device 14 may be used in the transmission of wireless commands to and from the control component 12. As such, wireless communication device 14 may be any wireless communication device used to transmit wireless communication to and from one or more remote devices that communicate wirelessly with the control component 12. For example, the wireless communication device 14 may be a wireless device that executes a two-way communication protocol, such as a MiWi and/or Zigbee protocol. In further embodiments, wireless communication device 14 communicates using 2.4 GHz protocols, including 2.4 GHz side bands or 2.4 GHz stacks. Additionally, in one example, wireless communication device 14 may execute a RF4CE protocol. In some embodiments, wireless communication device 14 is used to communicate wirelessly between the control component 12 and the remote device 26, which may also be referred to as a remote control.

In addition to communicating via wireless communication device 14, the control component 12 may also interact with external devices that are coupled to the control component 12, such as the automated furniture accessory 24 coupled to the CAN bus 16 of the control component 12. In embodiments, the CAN bus 16 may directly or indirectly couple one or more automated furniture accessories 24 to the control component 12. In one example, integrated features 18 may be directly coupled to the control component 12 (e.g., distributed with the control component 12 upon manufacture of the automated furniture device), while automated furniture accessories 24 may be coupled to the control component 12 at any time (e.g., after purchase of the automated furniture item having the control component 12). In other words, in some embodiments, automated furniture accessories 24 may be coupled to the control component 12 of an automated furniture item that was not sold with such accessories.

In embodiments of the present invention, remote device 26 may be used to control one or more automated furniture accessories 24 coupled to a control component 12 of an automated furniture item. For example, an automated furniture accessory 24, such as an electric heating blanket, may be plugged in to the CAN bus 16 of the control component 12. Upon connection with the CAN bus 16, items of information regarding the particular automated furniture accessory 24 plugged into the CAN bus 16 may be transmitted to the control component 12. Such items of information may include the identity of the automated furniture accessory 24, its manufacturer, a particular type of device (such as a type of heating blanket), general identifying information, placeholders, and other types of information that are identifiable by the control component 12. In some embodiments, items of identifying information may be retrieved from the automated furniture accessory 24 by the control component 12, by virtue of the connection via CAN bus 16.

Having received identifying information regarding the particular automated furniture accessory 24 plugged in to the CAN bus 16, control component 12 may then transmit one or more packets of information to the remote device 26, such as a remote control, according to a communication protocol. The remote device 26 receives the items of information over a wireless connection between the control component 12 and the remote device 26, utilizing the wireless communication device 14. In embodiments, the packets of information communicated between control component 12 and remote device 26 identify the particular automated furniture accessory 24 according to a protocol for communication between the control component 12 and the remote device 26. In further embodiments, control component 12 acts as a 2-way wireless/CAN bridge such that an automated furniture accessory 24 (e.g., an inexpensive CAN accessory) can receive direct commands from the remote device 26.

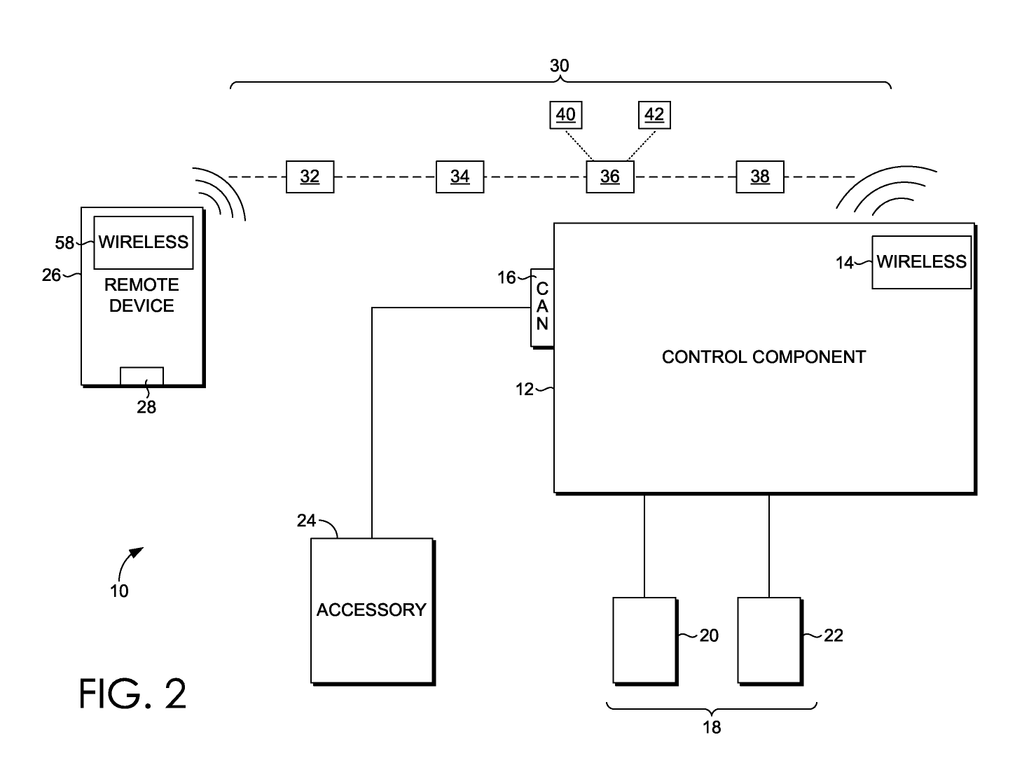

In another example, a communication protocol may specify particular packets of information that are required to be received by the remote device 26 before the remote device 26 can remotely direct the operation of the automated furniture accessory 24. Referring now to FIG. 2, packets of information 30 may be transmitted between control component 12 and remote device 26 using wireless communication device 14. Such exemplary packets may include a header packet 32, a message ID packet 34, message content packet 36, and a device ID packet 38. As will be understood, the type and number of packets transmitted as part of the communication protocol may vary, and any number of packets may be communicated between the control component 12 and the automated furniture accessory 24.

In one embodiment, header packet 32 provides information that identifies items such as a type of sender of a packet, a type of intended receiver of the packet, a message type, and the like. For example, header packet 32 may identify a control component 12 as the sender of a packet of data according to a communication protocol. In another embodiment, message ID packet 34 provides information regarding a CAN bus and/or MiWi wireless communication device 14 involved in a transmission according to a communication protocol. For example, a message ID packet 34 may identify CAN bus 16 as being involved with the transmission according to a communication protocol. As such, the header packet 32 and/or the message ID packet 34 provide identifying information regarding the sender and receiver of a message, and the type of message that will be transmitted using one or more devices.

In further embodiments, a message content packet 36 provides the content of a message transmitted according to a communication protocol. For example, a message content packet 36 may include instructions to manipulate one or more automated furniture accessories 24 coupled to the CAN bus 16 of a control component 12. As such, in some embodiments, message content packet 36 may include status data 40 and/or command data 42. In embodiments, status data 40 provides a status of one or more devices coupled to the control component 12. For example, status data 40 may indicate, as part of a message content packet 36, whether an automated furniture accessory 24 (such as a heating blanket) is turned to a highest power. Similarly, command data 42 may indicate, as part of a message content packet 36, a particular command directed at one or more devices coupled to the control component 12. For example, command data 42 may indicate, as part of a message content packet 36, a direction to manipulate one or more features of an automated furniture accessory 24 coupled to the control component 12, such as directing the lowering of temperature on a heating blanket.

In yet another embodiment, exemplary packets of information 30 may include a device ID packet 38 that specifically identifies one or more items of hardware coupled to the control component 12. For example, device ID packet 38 may indicate a particular type of automated furniture accessory 24 for control by the remote device 26. Accordingly, any number of device ID packets 38 may be transmitted between control component 12 and remote device 26.

In some embodiments, a communication protocol for controlling one or more automated furniture accessories 24 coupled to the control component 12 may include the transmission of one or more packets of information 30 between the control component 12 and the remote device 26. As such, in some embodiments, a control component 12 may determine one or more packets of information 30 to transmit to remote device 26. The determined one or more packets of information 30 may then enable the remote device 26 to control one or more automated furniture accessories 24 coupled to the control component 12, by virtue of the wireless connection between the remote device 26 and the control component 12.

In some embodiments, an automated furniture accessory 24 may be associated with one or more items of updateable information that may be changed after a user has initially coupled the particular automated furniture accessory 24 to the control component 12. In other words, after a remote device 26 has been configured to control a particular automated furniture accessory 24, one or more updates may become available for the automated furniture accessory 24. Accordingly, in some embodiments, the firmware of remote device 26 may be updated using data port 28. Data port 28 may be any feature associated with the remote device 26 that is capable of receiving data, such as a USB port. In one example, an updated feature of the automated furniture accessory 24 may be communicated to the control component 12 based on inputting the new and/or updated information into data port 28, such as plugging in a USB device containing such updated information.

In a further embodiment, a new and/or updated automated furniture accessory 24 may be coupled to the control component 12. In one embodiment, the control component 12 may be unable to recognize the newly-added automated furniture accessory 24. For example, the control component 12 may have been manufactured without the ability to recognize and/or process particular commands associated with the new and/or updated automated furniture accessory 24. In another example, the control component 12 may be unable to determine one or more items of information to communicate according to the communication protocol, in order to delegate control of the automated furniture accessory 24 to the remote device 26. As such, one or more updates may be provided to the remote device 26 via data port 28, and communicated from the remote device 26 to the control component 12 using wireless communication device 14. Accordingly, the remote device 26 may receive updates via data port 28, communicate such updates to the control component 12, and enable the control component 12 to exchange communication with the remote device 26 regarding the control of the automated furniture accessory 24.

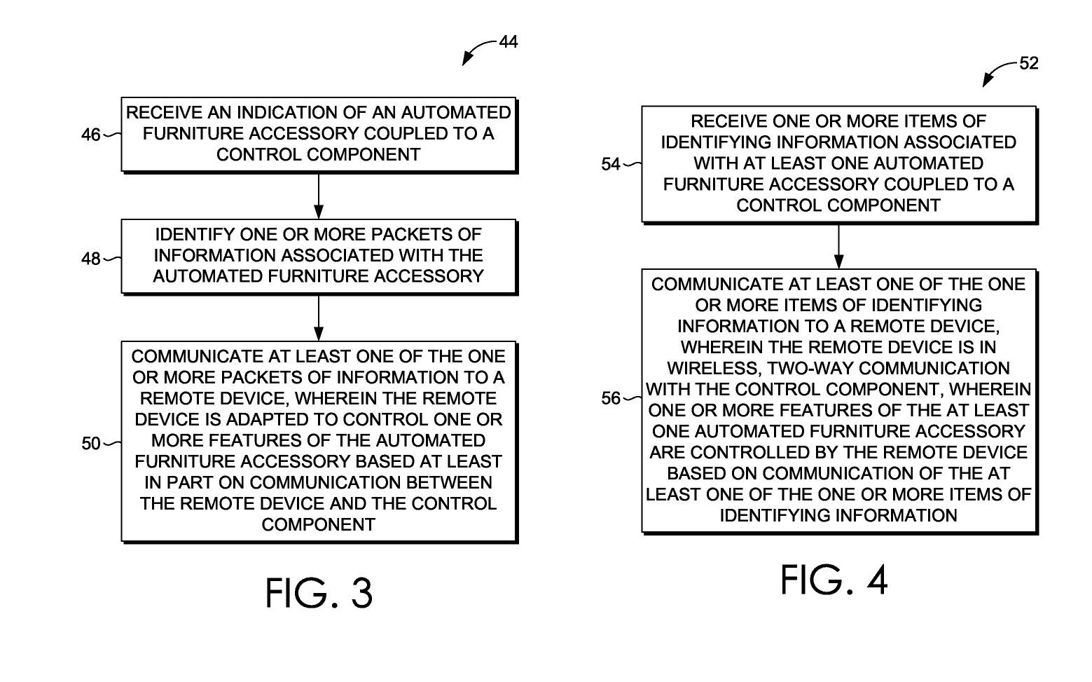

Referring next to FIG. 3, an exemplary flow diagram 44 of a method for integrating automated furniture accessories with automated furniture items is provided. At block 46, an indication of an automated furniture accessory coupled to a control component is received. For example, such an indication may be received based on plugging an automated furniture accessory 24 into a CAN bus 16. At block 48, one or more packets of information associated with the automated furniture accessory are identified. As discussed above, in some embodiments, a control component 12 may identify one or more items and/or packets of information 30 according to a communication protocol for control of the automated furniture accessory 24 by a remote device 26. As such, at block 50, at least one of the one or more packets of information is communicated to a remote device that is then adapted to control one or more features of the automated furniture accessory based on the communication between the remote device and the control component. For example, having received one or more packets of information 30 from the control component 12, the remote device 26 may control one or more features of the automated furniture accessory 24.

Turning now to FIG. 4, a flow diagram 52 of a method for integrating automated furniture accessories with automated furniture items is provided. At block 54, one or more items of identifying information associated with at least one automated furniture accessory coupled to a control component are received. For example, a control component 12 may receive items of identifying information (e.g., a device type or a manufacturer) associated with a particular automated furniture accessory 24. At block 56, at least one of the one or more items of identifying information is communicated to a remote device, with the remote device being in wireless, two-way communication with the control component, and one or more features of the at least one automated furniture accessory being controlled by the remote device based on communication of the at least one of the one or more items of identifying information. Accordingly, in one embodiment, features of an automated furniture accessory 24 may be controlled by the remote device 26 based on communication between the remote device 26 and the control component 12. In other words, by virtue of the direct connection of the automated furniture accessory 24 to the CAN bus 16 of the control component 12, as well as the wireless connection between the remote device 26 and the wireless communication device 14 of control component 12, the remote device 26 may control one or more features of the automated furniture accessory 24.

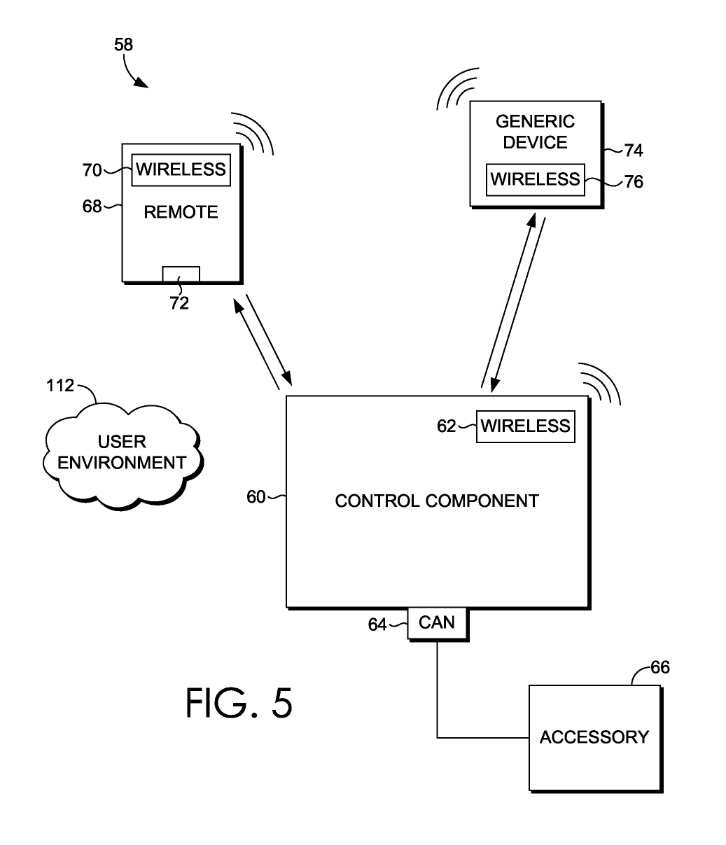

An embodiment of a system 58 for integrating automated furniture accessories and generic devices with automated furniture items is seen in FIG. 5. In the embodiment of FIG. 5, the system 58 generally includes a control component 60 having a wireless communication device 62, a controller area network (CAN) bus 64, and an automated furniture accessory 66 coupled to the CAN bus 64 of the control component 60. Further, the control component 60 is depicted as being in wireless communication with a remote device 68 having a wireless communication device 70 and a data port 72. In one embodiment, control component 60 controls various features of a user environment based on commands received by the control component 60. For example, the control component 60 may control generic device 74, having a wireless communication device 76 configured to communicate with the wireless communication device 62 of control component 60. As used herein, a generic device 74 refers to an external device configured to wirelessly couple to a control component of an automated furniture item. In one embodiment, a generic device refers to one or more devices used to establish a feature of a selected user environment, such as a lighting element, heating element, sound element, and/or other user environment device. Additionally, although a single, exemplary generic device 74 is shown in FIG. 5, it should be understood that any number or combination of generic devices 74 may be coupled to the control component 60.

In some embodiments, the control component 60 includes a processor and a memory capable of receiving and processing commands that are identifiable using the firmware of the control component 60. For example, the control component 60 may receive a command to operate one or more generic devices 74 in wireless communication with the automated furniture item coupled to control component 60. In one embodiment, the remote device 68 is a

Accordingly, a remote device 68 may receive an input command from a user, which the remote device 68 transmits, wirelessly, to the wireless communication device 62 of control component 60, using wireless communication device 70. The command may relate to one or more generic devices 74 in wireless communication with (i.e., wirelessly coupled to) the control component 60, such as a command to control a generic device external to the control component 60. In embodiments, remote device 68 is a wireless, handheld device, such as a remote controller, smartphone, and/or tablet device configured to communicate with the control component 60 using a wireless connection. In one embodiment, the remote device 68 is configured to communicate one or more commands to the control component 60, while in further embodiments, the remote device 68 provides an indication of presence to the control component 60. For example, in one embodiment, remote device 68 may be configured to provide an indication of proximity of a user of the remote device 68 to the control component 60 of an automated furniture item. In one embodiment, a proximity profile of a wireless remote device 68, such as a smartphone and/or tablet device, may provide an occupancy indication of a user of an automated furniture item.

In embodiments, wireless communication device 62 may be used in the transmission of wireless commands to and from the control component 60. As such, wireless communication device 62 may be any wireless communication device used to transmit wireless communication to and from one or more remote devices 68 that communicate wirelessly with the control component 60. For example, the wireless communication device 62 may be a wireless device that executes a two-way communication protocol, such as a MiWi and/or Zigbee protocol. In further embodiments, wireless communication device 62 communicates using 2.4 GHz protocols, including 2.4 GHz side bands or 2.4 GHz stacks. Additionally, in one example, wireless communication device 62 may execute a RF4CE protocol. In some embodiments, wireless communication device 62 is used to communicate wirelessly between the control component 60 and the remote device 68, which may also be referred to as a remote control.

In addition to communicating via wireless communication device 62, the control component 60 may also interact with external devices that are coupled to the control component 60, such as the automated furniture accessory 66 coupled to the CAN bus 64 of the control component 60. In embodiments, CAN bus 64 may directly or indirectly couple one or more automated furniture accessories 66 to control component 60. In one example, an automated furniture accessory 66 may be directly coupled to the control component 60 (e.g., distributed with the control component 60 upon manufacture of the automated furniture device), while in further embodiments, an automated furniture accessory 66 may be coupled to the control component 60 at any time (e.g., after purchase of the automated furniture item having the control component 60). In other words, in some embodiments, an automated furniture accessory 66 may be coupled to the control component 60 of an automated furniture item that was not sold with such accessories. In embodiments of the present invention, remote device 68 may be used to control one or more automated furniture accessories 66 coupled to a control component 60 of an automated furniture item. Accordingly, remote device 68 may be used to wirelessly control an automated furniture accessory 66 coupled to control component 60 based on a command communicated from wireless communication device 70 to wireless communication device 62.

In further embodiments, remote device 68 may be used to indirectly control one or more generic devices 74 wirelessly coupled to the control component 60. Accordingly, in some embodiments, a wireless communication protocol utilized between the wireless communication device 70 and the wireless communication device 62 may correspond to a wireless communication protocol utilized between the wireless communication device 62 and the wireless communication device 76. In one embodiment, packets of information communicated from remote device 68 to control component 60 (i.e., between wireless communication device 70 and wireless communication device 62, respectively), may identify a particular generic device 74 as an intended recipient device of the packets of information. For example, a command received from a user of the remote device 68 may provide instructions to the control component 60 to activate a particular feature of a user environment 112, such as dimming lights. Accordingly, a light fixture associated with generic device 74 may receive a command transmitted from wireless communication device 62 to wireless communication device 76. In other words, control component 60 serves as a central repository for commands related to the user environment 112, by virtue of the common wireless communication protocol utilized between the remote device 68, the control component 60, and the generic device 74.

In another example, a wireless communication protocol may specify particular packets of information communicated between the remote device 68 and the control component 60, and between one or more generic devices 74 and the control component 60. As discussed above with reference to FIG. 2, exemplary packets of information may be transmitted between a control component and a remote device, which may include a header packet, a message ID packet, message content packet, and a device ID packet. As will be understood, the type and number of packets transmitted as part of the wireless communication protocol may vary, and any number of packets may be communicated between the remote device 68 and the control component 60, and control component 60 and the generic device 74.

In one embodiment, a header packet provides information that identifies items such as a type of sender of a packet, a type of intended receiver of the packet, a message type, and the like. For example, a header packet may identify a control component 60 as the sender of a packet of data according to a wireless communication protocol. In another embodiment, a message ID packet may provide information regarding a CAN bus and/or MiWi wireless communication device involved in a transmission according to a communication protocol. For example, a message ID packet may identify CAN bus 64 as being involved with the transmission according to a communication protocol. As such, the header packet and/or the message ID packet provides identifying information regarding the sender and receiver of a message, and the type of message that will be transmitted using one or more devices.

In further embodiments, a message content packet provides the content of a message transmitted according to a wireless communication protocol. For example, a message content packet may include instructions to manipulate one or more generic devices 74 coupled to the control component 60 based on wireless communication between the wireless communication device 62 and the wireless communication device 76. As such, in some embodiments, a message content packet may include status data and/or command data. In embodiments, status data provides a status of one or more devices coupled to the control component 60. For example, status data may indicate, as part of a message content packet, whether a generic device 74 is turned on, and to what level of power it is currently set. Similarly, command data may indicate, as part of a message content packet, a particular command directed at one or more generic devices 74 coupled to the control component 60.

In yet another embodiment, exemplary packets of information may include a device ID packet that specifically identifies one or more items of hardware coupled to the control component 60. For example, a device ID packet may indicate a particular type of automated furniture accessory 66 for control by the remote device 68 (via control component 60). Accordingly, any number of device ID packets may be transmitted between control component 60 and remote device 68. In further embodiments, a device ID packet may indicate a particular type of generic device 74 for control by the remote device 68 (via control component 60).

In some embodiments, a communication protocol for controlling one or more generic devices 74 coupled to the control component 60 may include the transmission of one or more packets of information between the control component 60 and the remote device 68, and one or more packets of information between the control component 60 and the generic device 74. As such, in some embodiments, a control component 60 may determine one or more packets of information to transmit to remote device 68. The determined one or more packets of information may then enable the remote device 68 to indirectly control one or more generic devices 74 wirelessly coupled to the control component 60, by virtue of the wireless connection between the wireless communication devices 70, 62, and 76.

In some embodiments, generic device 74 may be associated with one or more items of updateable information that may be changed after a user has initially, wirelessly coupled the particular generic device 74 to the control component 60. In other words, after a remote device 68 has been configured to control a particular generic device 74 via the control component 60, one or more updates may become available for the generic device 74. Accordingly, in some embodiments, the firmware of remote device 68 may be updated using data port 72. Data port 72 may be any feature associated with the remote device 68 that is capable of receiving data, such as a USB port. In one example, an updated feature of the generic device 74 may be communicated to the control component 60 based on inputting the new and/or updated information into data port 72, such as plugging in a USB device containing such updated information.

In a further embodiment, a new and/or updated generic device 74 may be coupled to the control component 60. In one embodiment, the control component 60 may be unable to recognize the newly-added generic device 74. As such, one or more updates may be provided to the remote device 68 via data port 72, and communicated from the remote device 68 to the control component 60 using wireless communication devices 70 and 62. Accordingly, the remote device 68 may receive updates via data port 72, communicate such updates to the control component 60, and enable the control component 60 to exchange communication with the remote device 68 regarding the control of the generic device 74.

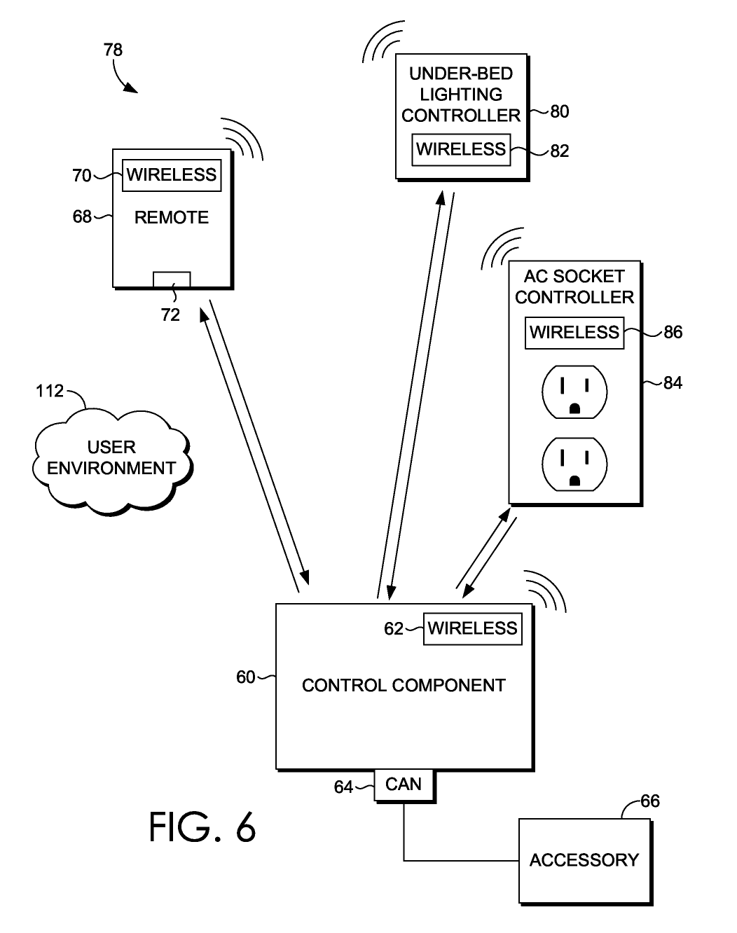

With reference to FIG. 6, an embodiment of a system 58 for integrating automated furniture accessories and generic devices with automated furniture items is shown. In the embodiment of FIG. 5, the system 78 generally includes a control component 60 having a wireless communication device 62, a controller area network (CAN) bus 64, and an automated furniture accessory 66 coupled to the CAN bus 64 of the control component 60. Further, the control component 60 is depicted as being in wireless communication with a remote device 68 having a wireless communication device 70 and a data port 72. In one embodiment, control component 60 controls various features of a user environment based on commands received by the control component 60. For example, the control component 60 may control multiple types of generic devices having wireless communication devices configured to communicate with the wireless communication device 62 of control component 60. In the exemplary embodiment of FIG. 6, the control component 60 is coupled to an under-bed lighting controller 80, having a wireless communication device 82, and an AC socket controller 84, having a wireless communication device 86. Although the control component is coupled to two “generic” devices (the under-bed lighting controller 80 and the AC socket controller 84) in FIG. 6, it should be understood that any number or combination of generic devices may be wirelessly coupled to the control component 60.

In one embodiment, a control component 60 may be used to establish a particular user environment 112, having one or more customizable features that satisfy one or more requests from a user of an automated furniture item. For example, the user of the automated furniture item coupled to control component 60 may provide an indication to the remote device 68 that the user selects a particular user environment setting, such as an evening setting from a set of “favorites” environment profiles. Upon selection of the particular user environment setting, the remote device 68 may communicate a set of commands to the control component 60 for distribution (by the control component 60) to one or more generic devices 74 coupled to the control component 60. As such, a single indication to the remote device 68 may trigger a series of commands to be executed by the various generic devices 74 coupled to the control component 60. In a further embodiment, in response to a single indication of a particular user environment (received by the remote device 68 and communicated to the control component 60), control component 60 determines a set of commands corresponding to the received user environment selection. In one embodiment, a set of commands corresponding to a selected user environment may include both commands for execution by a control component 60 and commands for execution by one or more generic devices coupled to the control component 60. For example, a control component 60 may be directly coupled to the motor of an automated bed, and wirelessly coupled to an external lighting fixture (i.e., a generic device). As such, a set of commands received by the control component 60 may be directed to an intended “recipient” of such commands based on the communication between the remote device 68, the control component 60, and one or more generic devices 74.

In another embodiment, a control component 60 may be used to establish a particular user environment 112 based on receipt of an indication of occupancy received by the control component 60 coupled to an automated furniture item.

For example, an occupancy detection system may be coupled to the control component 60, such as the capacitive occupancy detection system and/or method described in one or more of the following: U.S. Nonprovisional patent application Ser. No. 13/346,386, entitled “Capacitive Wire Sensing for Furniture,” filed Jan. 9, 2012; U.S. Nonprovisional patent application Ser. No. 13/749,120, entitled “Capacitive Wire Sensing for Furniture,” filed Jan. 24, 2013; and U.S. Nonprovisional patent application Ser. No. 13/854,720, entitled “Occupancy Detection for Furniture,” filed Apr. 1, 2013, the contents of all three of which is hereby incorporated by reference in its entirety. As such, a presence-sensing technology (e.g., a system coupled to and/or integrated with the control component 60, and/or method of presence-sensing performed by the control component 60 and/or additional components coupled to the control component 60) may be used to detect the presence or absence of a user of an automated furniture item. As such, a presence-sensing technology may be used to detect the presence or absence of a user of an automated furniture item. Based on such presence detection, the control component 60 may then direct the corresponding commands to generate a desired user environment 112 based on a previously-determined set of commands corresponding to a particular user environment setting. In embodiments, the commands corresponding to a particular user environment setting may be communicated from the control component 60 to one or more generic devices 74, such as an under-bed lighting controller 80 and/or AC socket controller 84.

For example, a control component 60 of an automated furniture item, such as a bed, may receive a command from a user via the remote device 68 to select an “evening” user environment setting. In response to the command input into the remote device 68, and communicated from the wireless communication device 70 to the wireless communication device 62 of the control component 60, the control component 60 may direct commands corresponding to one or more generic devices 74. For example, the control component 60 may deliver commands corresponding to one or more settings and/or energy levels of one or more generic devices 74. For example, to establish the “evening” user environment setting selected by a user of the remote device 68, the control component 60 may direct the under-bed lighting controller 80 to provide dimmed light, while the AC socket controller 84 may be directed to turn on a device plugged into the socket, such as a particular lamp. Accordingly, a subsequent indication of user presence received by the control component 60 may cause one or more changes to the settings established as part of the “evening” user environment setting. In some embodiments, based on the indication of the user's presence (e.g., detected using presence-sensing technology such as a capacitive wire sensing technology integrated into the automated furniture item), a predetermined set of commands corresponding to a particular “evening” favorites and/or user environment setting may be executed by the control component 60. As such, the control component 60 may deliver the corresponding commands to individual, generic devices 74 according to the detected change in presence sensing and its relation to the particular room settings. In embodiments, based on the wireless communication protocol between the control component 60 and the individual, generic devices 74, one or more features of the user environment 112 may be changed in response to commands received from the control component 60. In one example, a user's presence may be detected on an automated bed, after which the control component 60 coupled to the automated bed directs the under-bed lighting controller 80 to turn off the under-bed lights, and similarly, directs the AC socket controller 84 to turn off a lamp coupled to the AC socket controller 84. In another example, a user may temporarily exit the bed, at which time the control component 60 may direct the under-bed lighting controller 80 to illuminate, while the control component 60 need not also activate the AC socket controller 84. Accordingly, in response to a presence detection, a corresponding change in one or more features of a user environment may be triggered by a command received from the control component 60.

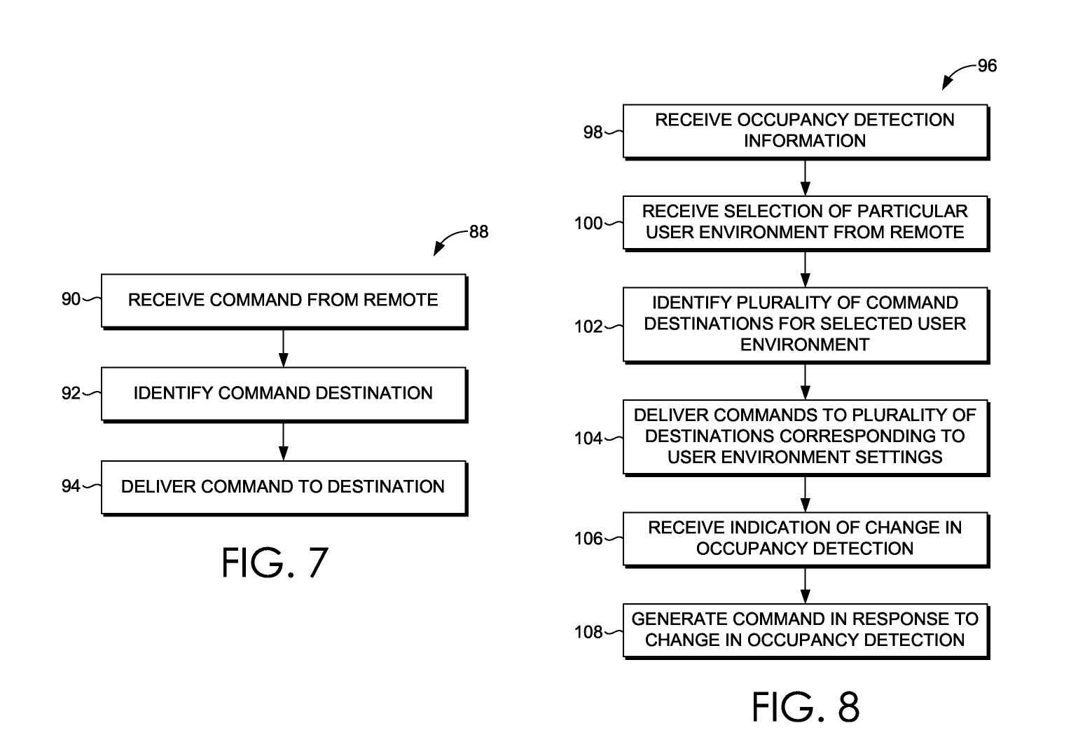

Referring next to FIG. 7, an exemplary flow diagram 88 for integrating generic devices with an automated furniture item is provided. At block 90, a command is received from a remote device. In embodiments, the received command may include a received selection of a particular user environment, while in other embodiments, the received command may correspond directly to a particular generic device coupled to the control component. At block 92, a command destination is identified for the received command. For example, a received command including a selection of a particular user environment may include multiple commands for delivery to multiple generic devices coupled to a control component. In another embodiment, the received command may relate directly to a particular generic device, for which the control component determines the command's destination (i.e., determines to send the command received from the remote device to the intended recipient—the particular generic device). As such, at block 94, a command is delivered to its destination.

Turning now to FIG. 8, a flow diagram 96 of a method for integrating generic devices with automated furniture items is provided. At block 98, occupancy detection information is received. At block 100, a selection of a particular user environment is received from the remote device. As such, at block 102, a plurality of command destinations are identified from the selected user environment. For example, a plurality of generic devices may correspond to the settings of a particular user environment, such as a generic device for lighting, a generic device for sound, etc. At block 104, the commands corresponding to the user environment settings are delivered (e.g., primary commands) to the plurality of destinations (e.g., multiple generic devices used to create the selected user environment and/or commands directed to the control component). Accordingly, at block 106, a subsequent change in occupancy detection is received by the control component of the automated furniture item, which indicates a change in occupancy since the initial occupancy determination was received. In response to the received change in occupancy, at block 108, a command(s) (e.g., secondary command(s)) is delivered to a destination, such as a subsequent command delivered to a particular generic device. For example, a user environment may be established having dimmed lights and light music. Upon an occupant exiting the automated furniture item, a command directing the lighting to increase in intensity may be delivered to a generic device, such as a lamp coupled to a wireless AC socket controller.

Returning now to embodiments of the present invention generally related to user identification for an automated furniture item using occupancy detection and proximity detection, in some embodiments, a BLE PXP may be utilized in association with one or more identifiable, responsive zones and/or environments, such as a particular area of functionality within a home and/or living environment. As such, in some embodiments of the invention, a control component of an automated furniture item may be configured to respond to one or more wireless remote devices within a particular responsive area, by virtue of a BLE PXP. For example, a smartphone within a home may be configured to control an automated bed (within the same home) when the smartphone enters a particular BLE range of the automated bed's control component. In some embodiments of the invention, satisfying a threshold indication of proximity may be required prior to eliciting a response by the user identification system/method. Accordingly, a proximity indication of a particular user (e.g., a detected proximity via a BLE PXP) may generate one or more corresponding, user-specific responses by the automated furniture item, as discussed in more detail below.

Embodiments of the invention utilize occupancy detection associated with an automated furniture item to enable and/or activate one or more features of the user identification system/method. In embodiments, the user identification system/method utilizes a capacitive detection feature such as a mylar detection pad to identify user occupancy and/or presence with respect to an automated furniture item. As such, in one embodiment of the invention, a capacitive detection system such as the capacitive sensing system described in one or more of the following U.S. patent applications may be associated with one or more features of the user identification system/method: U.S. Nonprovisional patent application Ser. No. 13/346,386, entitled “Capacitive Wire Sensing for Furniture,” filed Jan. 9, 2012; U.S. Nonprovisional patent application Ser. No. 13/749,120, entitled “Capacitive Wire Sensing for Furniture,” filed Jan. 24, 2013; and U.S. Nonprovisional application Ser. No. 13/854,720, entitled “Occupancy Detection for Furniture,” filed Apr. 1, 2013, the disclosure of all of which are hereby incorporated by reference in their entirety.

In further embodiments, occupancy detection associated with an automated furniture item, which enables and/or activates one of more features of the user identification system/method, may include one or more presence detection features, such as a pressure pad, a camera, an infrared detection system, a motion detection system, and the like. As such, in some embodiments of the invention, one or more detection methods may be used to provide an indication to a control component of an automated furniture item that presence has been detected with respect to at least a portion of the automated furniture item.

In one embodiment of the invention, at least in part in response to a received indication of proximity of a particular user to a control component of an automated furniture item, a user-specific interface may be generated on a particular user device, thereby providing one or more control features for one or more environments associated with the automated furniture item. For example, based on proximity of a particular user device detected with respect to a particular automated bed, a user-specific interface having controls for the particular automated bed's environment may be provided via a display of the particular user device.

In some embodiments of the invention, an indication of occupancy and/or an indication of user identification may trigger one or more automated responses by an automated furniture item, such as activating a favorites position, unlocking of a smart device associated with an automated furniture item, enabling of one or more pre-sets associated with an automated furniture item, unlocking additional features and/or functions programmed in the smart device, etc. As such, based on communication between a user's current/remote device and the control component of an automated furniture item, one or more features of the automated furniture item may be controllable via the user's current/remote device, such as a selection option that lets the user command the control component, via the current/remote device, to activate a particular favorites position of the automated furniture item. In further embodiments, a control device (such as the user's smartphone) may be sensed by the control component of an automated furniture item (via BLE), while the user's occupancy may be detected by the occupancy detection component coupled to the automated furniture item. Further, in response to such detection, a determination may be made as to which particular controls to “push” and/or communicate to the particular, identified user device. In some embodiments, one or more user-specific favorites positions, unlocked smart device controls, automated furniture pre-sets, and/or additional features/functions may be activated in association with the user-specific proximity and the user-specific occupancy detection of the particular user.

In some embodiments of the invention, one or more message notifications may be provided to a particular smart device, such as one or more “pushed” message notifications for a particular smart device. As such, an automated furniture item controller may provide a “push notification” to a smart device configured to control the automated furniture item. In further embodiments of the invention, in response to a received indication of occupancy detection and a received indication of one or more user commands, one or more hospitality settings may be engaged and/or activated in association with an automated furniture item. As such, in a first exemplary hospitality setting, a control component of an automated furniture item may identify that a particular user device is within a threshold proximity with respect to the control component of the automated furniture item (e.g., device A detected in first hospitality setting A). Further, in response to detection of occupancy of the particular user associated with the particular user device, one or more user-specific controls may be communicated to the particular user device.

For example, the user of device A may receive lighting and HVAC control options on an interface of the device A in response to proximity and/or occupancy detection within the first hospitality setting. In another environment, such as a second hospitality setting B, the user of device A may be detected by a control component associated with an automated furniture item in hospitality setting B. As such, one or more user-specific controls associated with hospitality setting B may be provided to device A for control of the second environment. In one embodiment, based on wireless communication between the control component of a particular environment (e.g., the control component of an automated furniture item in a first hospitality setting) and a user's current device (e.g., the user's smartphone device configured to communicate wirelessly with the control component of the automated furniture item), one or more settings associated with the first hospitality setting may be controlled by the user via the user's current device. In embodiments of the invention, the user's current device is configured to control the one or more settings in the first hospitality environment in response to proximity and occupancy detection with respect to the control component of the automated furniture item associated with the first hospitality environment. In one example, by communicating one or more commands for control to the control component, the user of the remote/current device may indirectly communicate commands to one or more additional/remote devices coupled to the control component (e.g., controlling a light fixture wirelessly coupled to the control component of an adjustable bed).

Embodiments of the invention may be utilized in a home healthcare environment for tracking and/or monitoring home healthcare activities, such as activity level of a patient. In response to monitoring one or more activities associated with the adjustable furniture item, in one embodiment, a report may be generated to provide an indication of activity to one or more clinical providers. As such, utilizing proximity detection and/or occupancy indicators, a home healthcare monitoring report may be generated, which indicates an amount of time a particular user was present in a particular position, such as the amount of time the particular person was present in an adjustable bed.

In further embodiments of the invention, one or more room settings associated with the automated furniture item may be activated in response to occupancy detection and user identification (via a BLE PXP). In one example, a user-specific room and/or environment setting involving lighting at a particular level and temperature at a particular level may be activated as part of a response to identification of the particular user and triggering occupancy with respect to the room/environment.

In another embodiment of the invention, based on one or more requirements and/or preferences provided by a user, one or more home security settings may be monitored and/or activated in response to the received indication of user occupancy and the received indication of user identification. As such, embodiments of the invention relate to wirelessly triggering generic devices by a command from the control component, such as a command to the home security system coupled to a control component of an automated furniture item. In further embodiments, upon determining a user identity and a user presence with respect to an automated furniture item, one or more Heating Ventilation and Air Conditioning (HVAC) settings may be executed in one or more room environments. As such, a triggering of threshold requirements with respect to occupancy and proximity may correspond to populating an interface of the user's remote device (e.g., a user interface of the user's smartphone) with one or more controls for HVAC settings. In embodiments, based on identification of a particular user's remote device and detection of user occupancy, user-specific environment controls may be provided to the user, such as one or more pre-sets, favorites, and/or customized conditions for HVAC control by the particular user.

In one embodiment of the invention, by synchronizing interaction between one or more smart devices and one or more automated furniture controllers, the one or more smart devices (i.e., tablets, smartphones, etc.) may be configured to function as an advanced remote for an automated furniture item, according to embodiments of the invention. As such, while a traditional remote device may control only a limited number of features directly associated with an automated furniture item, the synchronized smart device may be configured to receive more advanced remote controlling options, such as controls corresponding to environment settings that extend beyond a particular room. In another embodiment, the “advanced” remote capability for a smart device may be activated upon indication of both proximity and occupancy, with respect to a particular automated furniture item. In one example, the proximity of a particular user, as indicated via proximity of a particular user device, may generate one or more commands/controls for the particular user to execute on their remote device.

In some embodiments of the invention, the user identification method may be used to modify a room and/or an automated furniture item environment to one or more particular present conditions in response to occupancy detection upon entering the automated furniture item's detection range. Such modifications may be user specific, as indicated by virtue of a user-specific presence detection, and may also correspond to a received occupancy indication. Accordingly, some embodiments of the invention provide for a biometric activation of one or more features associated with an automated furniture item, such as a biometric activation that triggers an identification of one or more favorites positions associated with a particular user. In further embodiments, such biometric activation may generate and/or identify one or more pre-set activity states for one or more features associated with the automated furniture item. For example, upon triggering an identification of user identity, a control component of an automated furniture item may activate one or more pre-set conditions for accessories associated with the automated furniture item, such as a light. As such, embodiments of the invention are directed to utilizing various biometric inputs received by the control component of the automated furniture item, thereby enabling the manipulation of the automated furniture item by a particular user.

In addition to biometric data collected by the control component of an automated furniture item (in response to triggers via occupancy detection and/or presence detection), one or more additional inputs may be received, and utilized to determine a corresponding response by the automated furniture item. For example, various inputs, such as an indoor temperature, a seasonal indication, and/or a time of day or night, may provide additional input that corresponds to a received presence and/or occupancy detection.

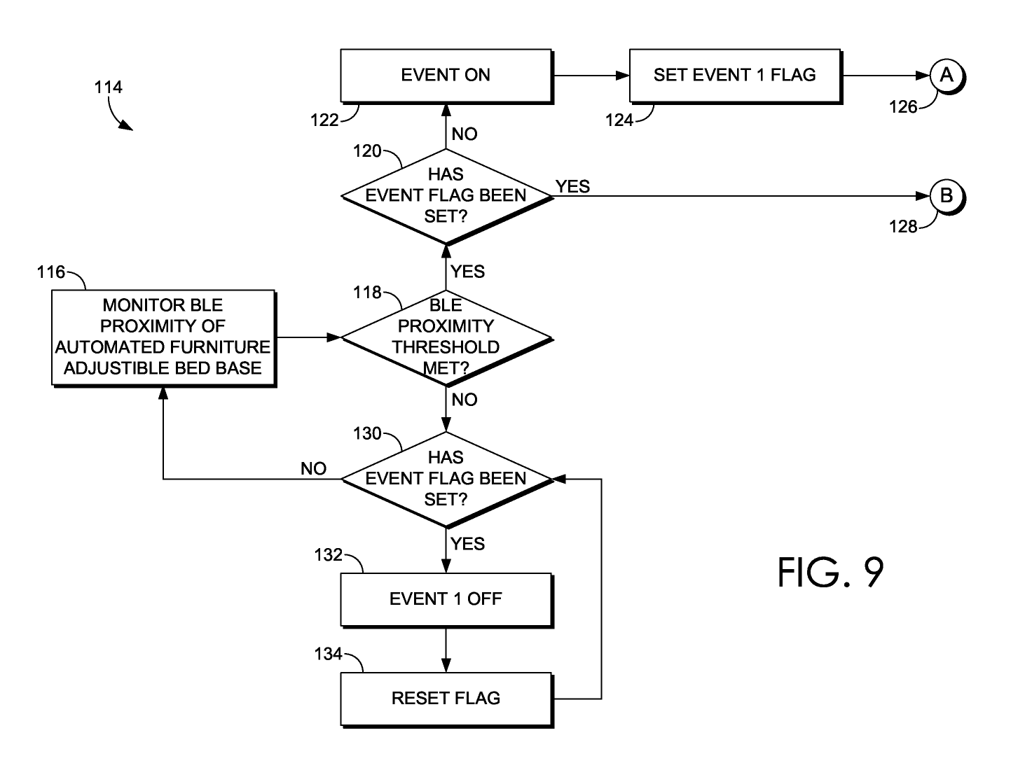

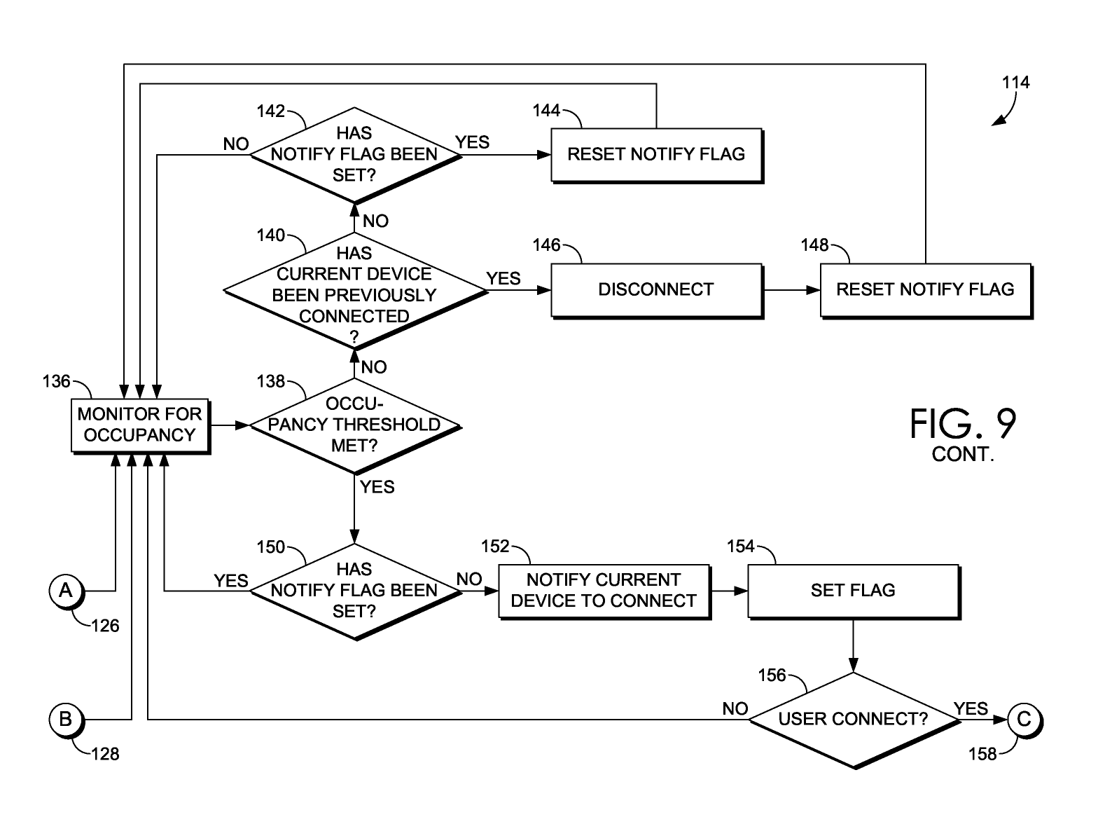

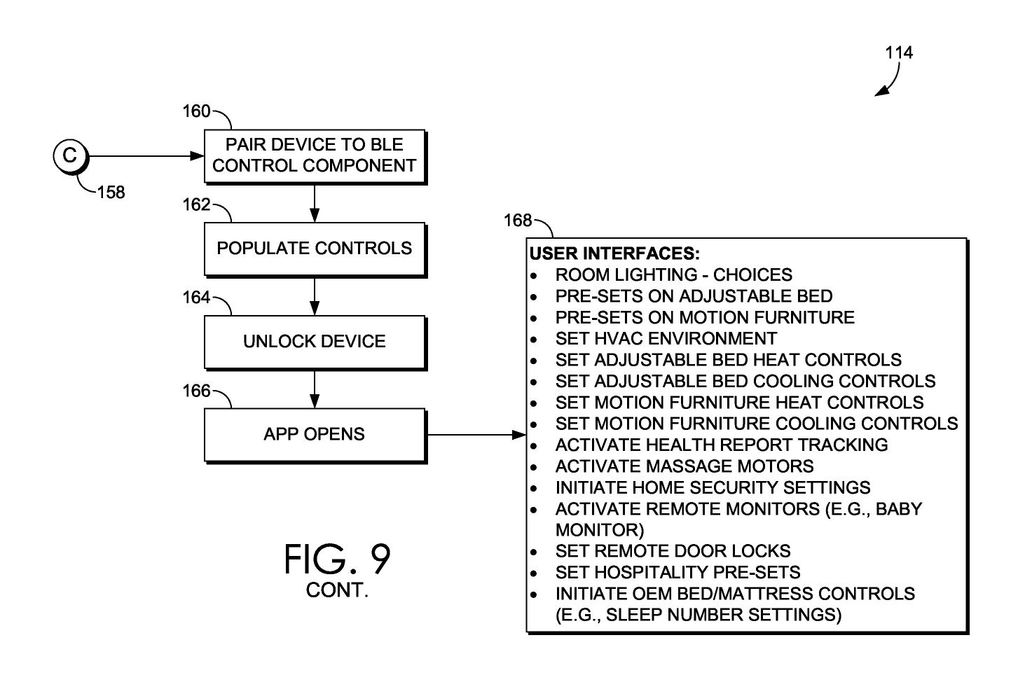

With reference now to FIG. 9, a flow diagram 114 of an exemplary method of user identification for an automated furniture item is depicted in accordance with an embodiment of the invention. At block 116, a BLE proximity of an automated furniture adjustable bed base is monitored. In some embodiments, the BLE proximity monitoring of FIG. 9 may be executed with respect to an automated furniture item, such as any automated furniture item configured to communicate via a wireless communication protocol. As shown in FIG. 9, in response to the monitoring at block 116, a determination is made at block 118 as to whether a BLE proximity threshold has been satisfied. For example, a control component of an automated furniture item may monitor for presence of a wireless device, such as a smart device within range of the control component. If it is determined that the BLE proximity threshold is satisfied, as shown at block 120, a further determination is made whether a flag has been set (i.e., whether a previous prompt to connect to a detected wireless device has been sent, in response to a threshold level of presence detected by the control component).

At block 122, if a previous attempt to connect to the detected remote device has not been made (i.e., a flag has not been set for a particular action), then the method of flow diagram 114 continues to trigger a corresponding event at block 122 and set an event flag at block 124 prior to proceeding to a next step A at 126. If it is determined at block 120 that a previous attempt to connect to the detected remote device has already been made, then the method of flow diagram 114 proceeds to a next step B at 128.

Additionally, upon determining that a proximity threshold has not been met at block 118, based on the monitoring at block 116, a corresponding determination regarding whether a flag has been set may be made at block 130, and necessary events may be triggered at block 132 and flags may be reset at block 134.

With continued reference to FIG. 9, based on following the method flowing from step A at 126 or step B at 128, the control component of the automated furniture item (e.g., the automated bed) monitors for an indication of occupancy at block 136. A determination may then be made as to whether an occupancy threshold has been met, at block 138. If it is determined that the occupancy threshold has not been met, a determination may be made at block 140 as to whether the current device has been previously connected to the control component of the automated furniture item. As such, in some embodiments, even though a particular threshold for occupancy may not have been detected yet, if a particular user's presence is detected with respect to a control component via presence detection of the particular user device, a determination may still be made whether to trigger notification of the user's device regarding control of the automated furniture item. Accordingly, at block 142, if the detected user/current device has not been previously connected to the automated furniture item, an assessment of whether a notify flag has been set may be triggered at block 142. If the flag has not been set, capacitance may continue to be monitored at block 136. If a flag has been previously set, then a notify flag may be reset at block 144 and monitoring may continue at block 136.

Upon determining that a current device has been previously connected to a control component of an automated furniture item, an indication to disconnect may be initiated at block 146, while a notify flag is reset at block 148. As such, in the example of an occupancy threshold not being met yet, at block 138, a notify flag assessment may precede the continued monitoring at block 136.

Upon determining that an occupancy threshold has been met at block 138, a determination may be made as to whether a notify flag has been set at block 150. If not, the notification to connect a current device to the control component of the automated furniture item (i.e., the adjustable bed) is provided at block 152. As such, at block 154 a flag may be set and a user may be prompted as to whether they would like to connect their remote/wireless device to the control component, at block 156. If an indication not to connect is received, monitoring may continue at block 136. If an indication to connect is received at block 156, the method of flow diagram 114 may continue at step C at 158.

Referring further to FIG. 9, on step C at 158, the user's wireless/remote device may be paired to the BLE control component of the automated furniture item. In one example, at block 160, a user's smartphone may be paired to the BLE component of the automated furniture item. At block 162, based on pairing the smartphone and/or wireless user device to the control component, one or more controls may be populated in association with the user's device. For example, one or more controls associated with the operation of the automated furniture item may be populated on a user interface of the user device at block 162. At block 164, the user device becomes unlocked, and at block 166, upon opening an application associated with the user device, a user interface having one or more prompts may be provided to the user, as shown at block 168.

In embodiments of the invention, in response to a monitoring of proximity and occupancy with respect to the control component of the automated furniture item (i.e., the BLE proximity monitoring at block 116 and the occupancy monitoring at block 136), a determination may be made as to whether the one or both of those determinations satisfies a threshold requirement to trigger prompting a user to connect their wireless device to the automated furniture item. For example, at block 118, a determination may be made as to whether the BLE proximity threshold has been met, where to satisfy such threshold, the user's remote device must be within a particular peering zone of the control component, such as within range of the wireless BLE feature of the control component. In further embodiments, at block 138, a determination may be made as to whether the triggered occupancy detection satisfies a threshold level of occupancy indication, such as a particular level of change in presence detection that is required before triggering an invitation to connect the user's device with the control component. In one example, an occupancy detection that satisfies the threshold requirement may include an occupancy detection of a particular signal strength for a particular amount of time. As such, a user that merely bumps into an adjustable bed may provide an indication of temporal occupancy but does not dwell within a detection zone of the adjustable bed long enough to trigger actual occupancy. As such, in some embodiments of the invention, a user's device may be populated with one or more of the controls included at block 168 based on satisfying a minimal threshold level of proximity and/or occupancy required to trigger an authorization to connect the user device to the control component.

As shown in FIG. 9, multiple different features associated with an automated furniture item may be included as part of a user interface in response to the triggered proximity and occupancy of an automated furniture item. For example, the user device may provide controls that enable the user to access various room lighting settings, based on one or more lights in a room being in wireless communication with the control component. In further embodiments, the user device may be populated with one or more pre-sets for the adjustable bed and/or one or more pre-sets for a motion furniture item. Additionally, a user may be permitted, via an application executed by the user's device, to set and/or adjust one or more features of an external environment corresponding to the automated furniture item, such as setting and/or adjusting the HVAC environment, the adjustable bed heat controls, the adjustable bed cooling controls, the motion furniture heat controls, the motion furniture cooling controls, and the like. In embodiments, one or more remote devices configured to receive communication from the wireless component of the wireless communication device may indirectly receive commands from the user's wireless device via the control component.

In some embodiments, the user interface of the remote device executing an application (in response to prompting from the control component of the automated furniture item) may be configured to provide a trigger to activate one or more tracing and/or monitoring features of the automated furniture item. As shown in the example of FIG. 9, at block 114, some embodiments of the invention include an option to activate health report tracking, an option to activate massage motors, an option to initiate home security settings, and an option to activate remote monitors. In further embodiments, a user interface may provide one or more options to coordinate and/or command one or more features and/or functions external to the control component, such as the setting of remote door locks, the setting of particular hospitality pre-sets (i.e., environment settings), and the initiation of a particular Original Equipment Manufacturer (OEM) controls, such as a particular vendor's bed and/or mattress configuration. In one example, upon detecting presence of a particular user with respect to an automated furniture item (i.e., via BLE PXP and occupancy detection), the user's remote device may be paired to the control component such that the user's remote device is configured to control one or more external components associated with the automated furniture item.

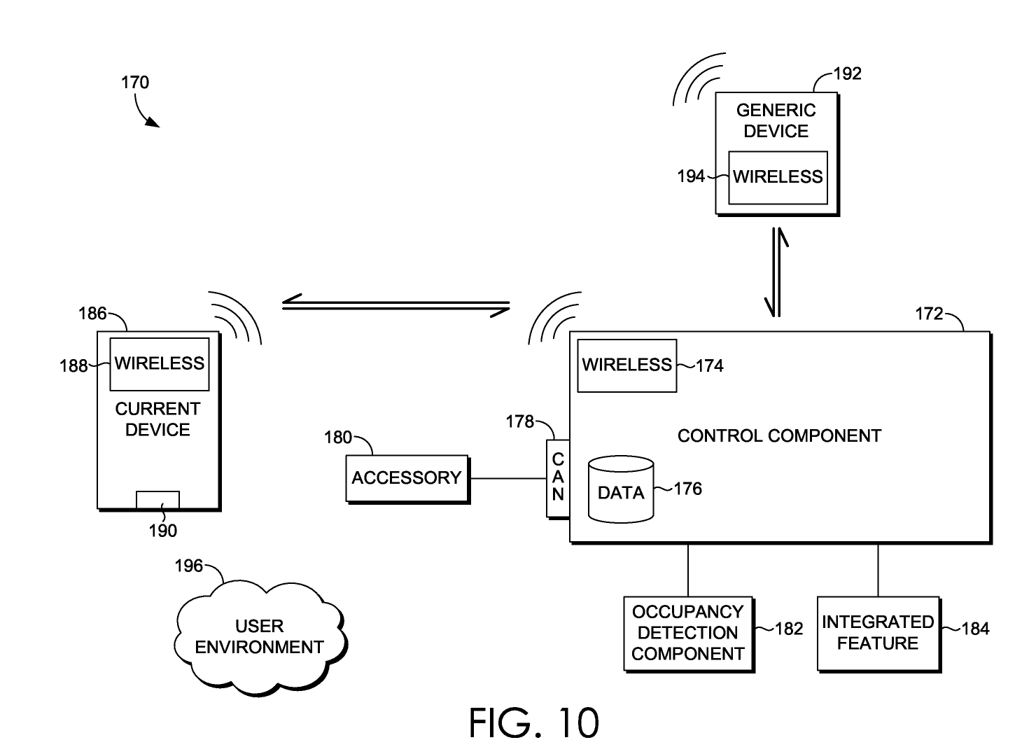

Referring next to FIG. 10, an exemplary diagram of a system 170 for user identification for an automated furniture item is provided. In embodiments, the system 170 includes a control component 172 for controlling an automated furniture item. The control component 172 may include a wireless communication device 174, such as a wireless device configured to communicate via one or more wireless communication protocols (e.g., BLE). Additionally, the control component 172 may include a database 176 configured to store one or more items of information associated with the control component 172, such as one or more items of data corresponding to a PXP.

As further shown in FIG. 10, a CAN bus 178 may be coupled to the control component 172 for coupling an accessory 180 directly to the control component 172. In further embodiments, control component 172 may be configured to receive indications from an occupancy detection component 182 coupled to the control component 172. As discussed above, in one example, the occupancy detection component 182 may provide an indication to the control component 172 of a triggered threshold for occupancy with respect to the automated furniture item. In further embodiments, an additional, integrated feature 184 may be coupled to the control component 172, such as a motor coupled directly to one or more portions of an automated furniture item.

With continued reference to FIG. 10, the wireless communication device 174 of the control component 172 may be wirelessly coupled to one or more remote devices, such as the current device 186 and the generic device 192. In one embodiment, the wireless communication device 174 of control component 172 is in wireless communication with the wireless communication device 188 of the current device 186. In embodiments, the current device 186 includes a data port 190 configured to couple to an external device, such as a USB device for receiving updates to the current device 186. In some embodiments, the current device 186 is configured to communicate with the control component 172 using a BLE PXP. As such, current device 186 may be detected based on a proximity of current device 186 in relation to the control component 172.

In further embodiments, a generic device 192 may also be coupled to the control component 172. In some embodiments of the invention, based on communication between the wireless communication device 194 of the generic device 192 and the wireless communication device 174 of the control component 172, the paired current device 186 may be configured to control one or more features of the generic device 192, based on a command communicated from the current device 186 to the control component 172, and a subsequent command communicated from the control component 172 to the generic device 192. As such, in some embodiments of the invention, a proximity indication and/or occupancy indication received by the control component 172 may trigger the communication of a connection request from the control component 172 to the current device 186. Having received an affirmative response from the user of the current device 186 to execute one or more controls associated with the control component 172, the current device 186 may then receive one or more commands on an interface for selection and/or control of the control component 172 and/or related generic devices 192.

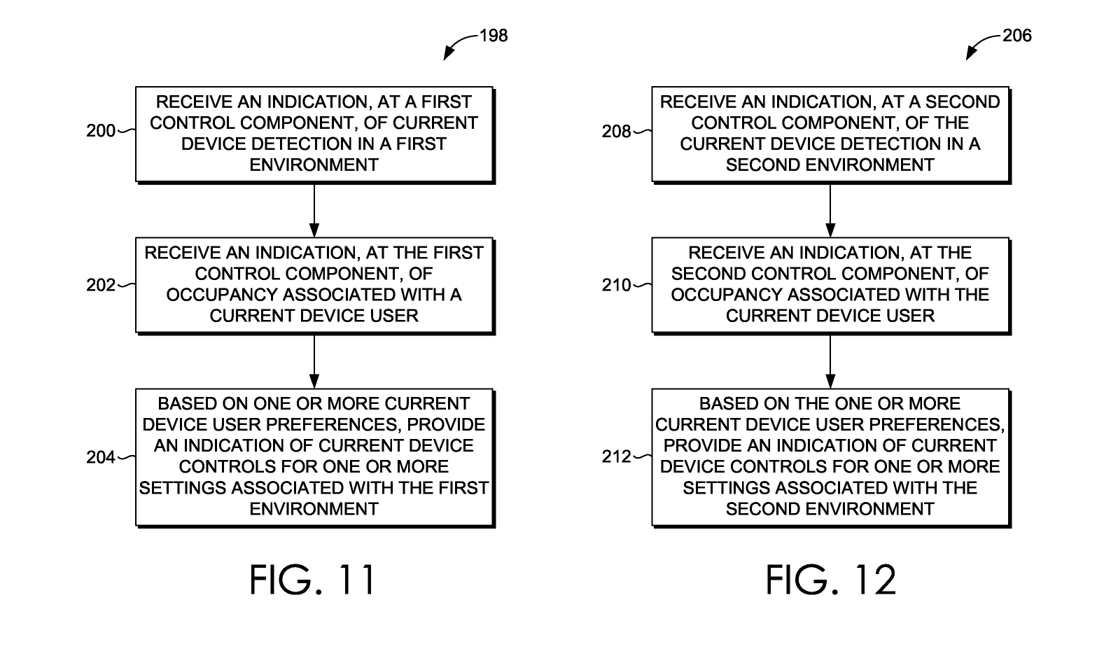

Turning next to FIGS. 11 and 12, flow diagrams of exemplary methods of user identification for an automated furniture item are provided. In one embodiment of the invention, the method 198 of FIG. 11 includes receiving an indication, via a first control component, of a current device detection in a first environment, at block 200. At block 202, an indication is received, at the first control component, of occupancy associated with the current device user. As such, at block 204, based on one or more current device user preferences (e.g., one or more particular user preferences associated with a current device 186), an indication of current device controls is provided for one or more settings associated with the first environment. For example, a user of a current device may come into “range” of a first control component in a first environment (e.g., a user's smartphone is within threshold proximity and/or distance of a first automated furniture item's control component). As such, the first control component may provide an indication of one or more current device controls for one or more settings associated with the first environment. In one exemplary hospitality setting, a hotel room may be equipped with two floor lamps and a ceiling fixture, all of which are controllable via the control component of the adjustable bed. In response to detection of the proximity of the particular user/current device (i.e., within the hotel room, satisfying a proximity threshold) and in response to detection of occupancy of the adjustable bed (i.e., sitting on the bed, satisfying an occupancy threshold), the control component may determine that this particular user has entered the room and is occupying an adjustable bed with one or more available control features. The one or more available control features may then be communicated to the user's current device, such as one or more commands populating the user device for controlling of the exemplary two floor lamps and single ceiling fixture. In one example, according to one or more user preferences corresponding to one or more potential controls for one or more settings of the first environment, a particular type and/or number of current device controls may be provided in association with the settings of a particular environment. For example, for a first environment, a particular user may have a particular set of preferences for one or more settings that the user would like to control, such as, for example, lighting and room temperature. In one example, a user may have particular preferences that, for each hotel environment, the user wishes to control only the lighting and heating/cooling of the environment, and the user need not be presented with controls related to any other controllable features coupled to the control component of the automated bed.

As shown in FIG. 12, the method 206 for an embodiment of the present invention includes receiving an indication of detection, at a second control component, of the user's current device in a second environment. For example, the user's smartphone may be detected as being within a threshold proximity and/or distance of a second environment, such as a second hotel room. At block 210, the second control component (e.g., the control component of the automated bed in the second environment) may receive an indication of occupancy associated with the current device user. In one embodiment, while a BLE PXP may be used in some embodiments to identify an indication of presence of a particular current device, one or more determinations may be made regarding whether the particular user triggering occupancy with respect to a control component is the particular user of the current device. In some embodiments, the trigger at block 208 of presence detection, and the trigger at block 210 of occupancy detection, must occur within a particular timeframe in relation to each other in order to provide an indication to the control component of the identity of a particular user.

With continued reference to FIG. 12, at block 212, an indication of current device controls for one or more settings associated with the second environment may be provided to the current device based on one or more current device user preferences. As such, in one example, the current device controls provided for one or more settings associated with the second environment at block 212 may be different from the current device controls for one or more settings associated with the first environment at block 204. In one example, the same user of the current device may then utilize a single “current” device to control an automated furniture item in a first environment (i.e., a first hotel room) and in a second environment (i.e., a second hotel room), based on one or more user preferences communicated to the first control component and the second control component.

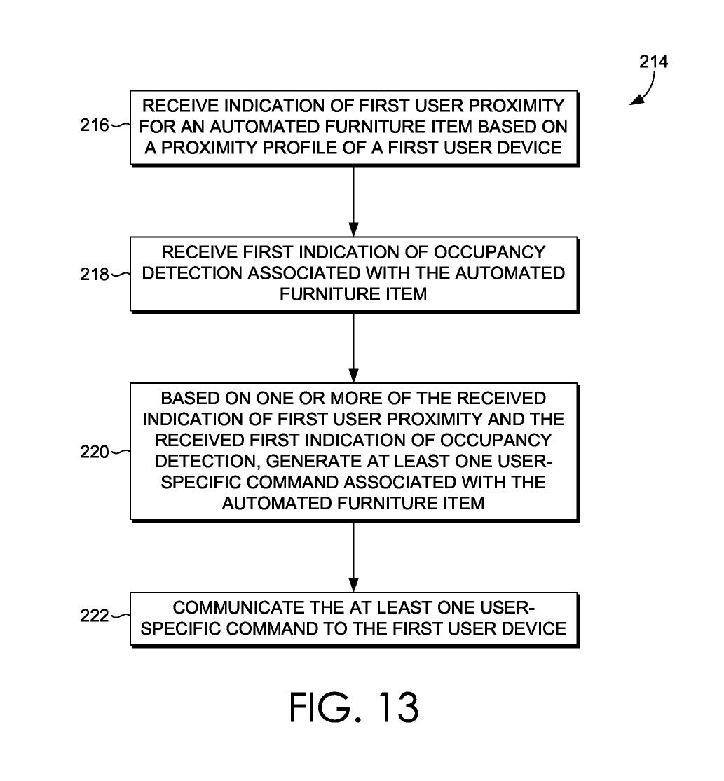

With reference to flow diagram 214 of FIG. 13, an exemplary method of user identification for an automated furniture item includes receiving, at block 216, an indication of first user proximity for an automated furniture item based on a proximity profile of the first user device. At block 218, an indication of occupancy detection associated with the automated furniture item is received. Further, at block 220, based on one or more of the received indication of first user proximity and the received first indication of occupancy detection, at least one user-specific command may be generated in association with the automated furniture item. At block 222, the at least one user-specific command is communicated to the first user device.

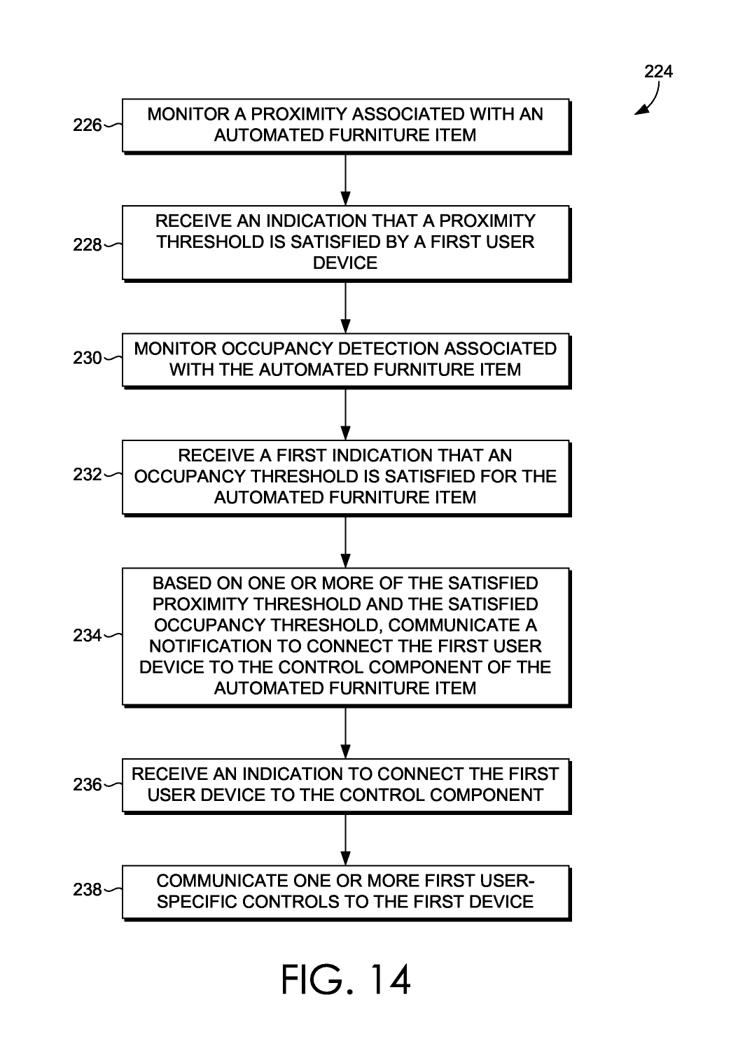

In FIG. 14, an exemplary method 224 of user identification for an automated furniture item is provided in accordance with embodiments of the invention. At block 226, a proximity associated with an automated furniture item is monitored. At block 228, an indication is received that a proximity threshold is satisfied by the first user device. At block 230, occupancy detection associated with the automated furniture item is monitored, while at block 232, a first indication is received that an occupancy threshold has been satisfied for the automated furniture item. In response to both the proximity determination and the occupancy indication, at block 234, the control component may be configured to communicate a notification to connect the first user device to the control component of the automated furniture item. An indication may be received at block 236 to connect the first user device to the control component. Finally, at block 238, one or more first user-specific controls may be communicated to the first device. As such, having one or more user-specific controls communicated to the first device at block 238 may include providing only those controls that correlate to a particular function of the environment of the automated furniture item, and/or the functionality of the furniture item itself.

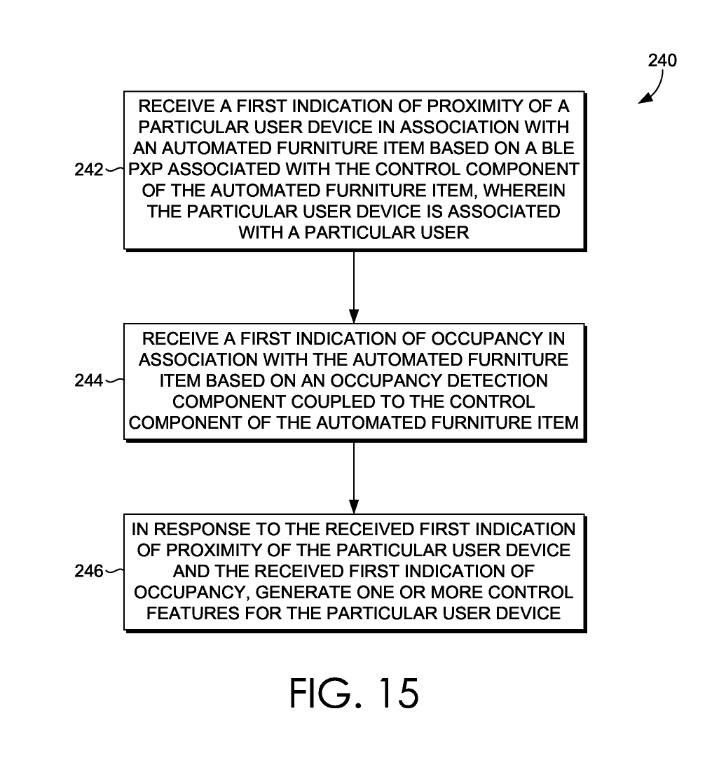

Referring finally to FIG. 15, a flow diagram of an exemplary method 240 of user identification for an automated furniture item is depicted according to one embodiment of the invention. In the method 240, at block 242, a first indication of proximity is received. Such first indication of proximity of a particular user device in association with an automated furniture item may be based on a BLE PXP associated with the control component of the automated furniture item, with the particular user device being associated with the particular user. At block 244, a first indication is received regarding occupancy. Such first indication of occupancy in association with an automated furniture item may be based on an occupancy detection component coupled to the control component of the automated furniture item. As such, at block 246, in response to the received first indication of proximity of the particular user device and the received first indication of occupancy (i.e., the occupancy of the user of the particular user device), one or more user-specific control features are generated for the particular user device. As such, upon detection by the automated furniture item of both the presence of a particular user and the occupancy of that particular user, embodiments of the present invention relate to the generation and/or communication of one or more user-specific control features.

From the foregoing, it will be seen that this invention is one well adapted to attain all the ends and objects hereinabove set forth together with other advantages, which are obvious and inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense

From the foregoing, it will be seen that this invention is one well adapted to attain all the ends and objects hereinabove set forth together with other advantages, which are obvious and inherent to the structure. It will be understood that certain features and subcombinations are of utility and may be employed without reference to other features and subcombinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

1. A user identification method for automated furniture, the method comprising:
receiving, by a control component of an automated furniture item, an indication of first user proximity based on a proximity profile of a first user device;
based at least in part on the received indication of first user proximity, generating at least one first user-specific command associated with the automated furniture item; and
communicating the generated at least one first user-specific command to the first user device.

2. The method of claim 1, further comprising:
based on the received indication of first user proximity, communicating a connection request to the first user device; and
receiving an indication to connect the first user device to the automated furniture item.

3. The method of claim 1, further comprising:
receiving, by the control component of the automated furniture item, a first indication of occupancy detection associated with the automated furniture item;
based at least in part on the received indication of first user proximity and the received first indication of occupancy detection, generating the at least one first user-specific command associated with the automated furniture item.

4. The method of claim 3, further comprising:
based on the received indication of first user proximity and the received first indication of occupancy detection, communicating a connection request to the first user device; and
receiving an indication to connect the first user device to the automated furniture item.

5. The method of claim 3, wherein receiving a first indication of occupancy detection associated with the automated furniture item comprises determining that an occupancy threshold has been met.

6. The method of claim 1, further comprising determining that the first user device was previously connected to the control component of the automated furniture item.

7. The method of claim 1, further comprising:
receiving, by the control component of the automated furniture item, an indication of a second user proximity based on a proximity profile of a second user device;
based at least in part on the received indication of second user proximity, generating at least one second user-specific command associated with the automated furniture item; and
communicating the generated at least one second user-specific command to the second user device.

8. The method of claim 7, further comprising:
receiving, by the control component of the automated furniture item, a second indication of occupancy detection associated with the automated furniture item;
based at least in part on the received indication of second user proximity and the received second indication of occupancy detection, generating the at least one second user-specific command associated with the automated furniture item.

9. A user identification method for automated furniture, the method comprising:
monitoring, via a control component of an automated furniture item, a proximity associated with an automated furniture item;
receiving an indication that a proximity threshold is satisfied by a first user device;
monitoring occupancy detection associated with the automated furniture item;
receiving a first indication that an occupancy threshold is satisfied for the automated furniture item;
based on one or more of the satisfied proximity threshold and the satisfied occupancy threshold, communicating a notification to connect the first user device to the control component of the automated furniture item;
receiving an indication to connect the first user device to the control component; and
communicating one or more first user-specific controls to the first user device.

10. The method of claim 9, further comprising:
receiving an indication that a proximity threshold is satisfied by a second user device;
receiving a second indication that an occupancy threshold is satisfied for the automated furniture item;
communicating a notification to connect the second user device to the control component of the automated furniture item;
receiving an indication to connect the second user device to the control component; and
communicating one or more second user-specific controls to the second user device.

11. The method of claim 9, wherein communicating a notification to connect the first user device to the control component of the automated furniture item comprises determining that a notification to connect the first user device to the control component has not been previously sent within a particular time period.

12. The method of claim 9, wherein receiving an indication to connect the first user device to the control component comprises automatically receiving an indication from the first user device in response to the notification communicated to the first user device to connect the first user device to the control component.

13. The method of claim 9, wherein receiving an indication to connect the first user device to the control component comprises receiving an indication from a user of the first user device in response to a prompt associated with the notification communicated to the first user device.

14. The method of claim 9, wherein communicating one or more first user-specific controls to the first user device comprises generating at least one first user-specific command associated with the automated furniture item.

15. The method of claim 14, wherein generating the at least one first user-specific command associated with the automated furniture item comprises generating at least one first user-specific hospitality setting control associated with a user environment of the automated furniture item.

16. The method of claim 9, further comprising:
generating, in response to 1) monitoring the proximity associated with the automated furniture item and 2) monitoring occupancy detection associated with the automated furniture item, tracking one or more user activities associated with a first user of the first user device.

17. A method for user identification for an automated furniture item utilizing occupancy detection and a BLE PXP, the method comprising:
receiving a first indication of proximity of a particular user device in association with the automated furniture item based on a BLE PXP associated with the control component of the automated furniture item, wherein the particular user device is associated with a particular user;
receiving a first indication of occupancy in association with the automated furniture item based on an occupancy detection component coupled to the control component of the automated furniture item; and
in response to the received first indication of proximity of the particular user device and the received first indication of occupancy, generating one or more control features for the particular user device.

18. The method of claim 17, further comprising:
determining whether the one or more control features have been provided to the particular user device;
upon determining that the one or more control features have not been provided to the particular user device, communicating the one or more control features to the particular user device for presentation to the particular user; and
upon determining that the one or more control features have been provided to the particular user device, monitoring for one or more of a second indication of proximity and a second indication of occupancy.

19. The method of claim 17, further comprising:
determining that the particular user device was previously coupled to the control component; and
in response to determining that the particular user device was previously coupled to the control component, automatically communicating at least one of the one or more control features to the particular user device.

20. The method of claim 17, wherein the one or more control features comprises:
one or more environment lighting controls;
one or more pre-set articulated positions associated with the automated furniture item;
one or more pre-set articulated positions associated with an external automated furniture item coupled to the automated furniture item;
one or more HVAC controls;
one or more automated furniture item heating controls;
one or more automated furniture item cooling controls;
one or more heating controls for the external automated furniture item coupled to the automated furniture item;
one or more cooling controls for the external automated furniture item coupled to the automated furniture item;
one or more health report tracking features;
one or more massage controls;
one or more home security settings controls;
one or more remote monitor controls;
one or more remote door locks controls;
one or more hospitality pre-set environment controls; and
one or more OEM automated furniture item controls.
